(19) United States
(12) Patent Application Publication
(10) Pub. No.: US 2023/0049920 A1
(43) Pub. Date: Feb. 16, 2023

(54) SYSTEMS AND METHODS INVOLVING RICH CONTACTS FOR PRE-PHONECALL COMMUNICATION

(71) Applicant: PICK UP MOBILE (2015) LTD, Ramat Hashofet (IL)

(72) Inventor: Lior SHACHAM, Ramat Hashofet (IL)

(21) Appl. No.: 17/789,632

(22) PCT Filed: Dec. 30, 2020
(86) PCT No.: PCT/IL2020/051360

§ 371 Date: Jun. 28, 2022

Related U.S. Application Data
(60) Provisional application No. 62/955,474, filed on Dec. 31, 2019.

(51) Int. Cl. H04M 3/42; H04M 1/57; H04M 1/27453; H04M 1/2757

(52) U.S. Cl. CPC H04M 3/42051; H04M 1/575; H04M 3/42059; H04M 1/27453; H04M 1/2757; H04M 2201/38; H04M 2203/2038

(57) ABSTRACT

systems and methods for communication prior to acceptance of a phone call. A method of the present invention that is comprised the steps of: generating a phone number; generating a message to be presented upon receipt of a phone call; generating a Rich Contact containing said message and said phone number; transmitting the Rich Contact to a recipient phone device and further storing it therein; initiating a phone call bearing a phone number of the Rich Contact to said recipient phone device; wherein, upon receipt of the phone call on the phone device, a default call application shall identify said phone number of said phone call and present said message from said Rich Contact associated with the phone number.

### FIELD OF THE INVENTION

This invention generally relates to systems and methods for communicating with a phone call recipient prior to accepting a phone call. More specifically, the present invention relates to methods and systems for communicating with a phone call recipient prior to accepting a phone call using ‘Rich Contacts’ functionality.

### BACKGROUND OF THE INVENTION

Many organizations that employ telephone communication with their audience seek innovative ways and methods to allow them to convey information prior to the recipient answering the phone call.

Such organizations seek mainly to inform the phone call recipient regarding the identity of the caller and the purpose of the call, since such corporate callers often use varying phone numbers that the recipient would not recognize or care enough to answer the call.

Therefore, means that will allow callers to communicate with a recipient prior of selecting up the phone call, are in high demand, as such means may motivate the recipient to actually select up the call.

Various attempts at solving the above problem have been made. For example, a mobile application known by the name Truecaller™ enables a user that holds a telephone number to indicate a name to associate with his phone number. Next time that this user calls another user of the Truecaller application, the application will identify the phone number by the indicated name even though the phone number was not previously known to the recipient's phone. This functionality is performed by comparing the incoming phone number against entries in a distant database operated by Truecaller™.

Although the described approach allows a caller to communicate with the recipient prior to the recipient answering the phone call, it has several drawbacks.

Firstly, such approaches require a continuous internet connection to access a remote database that contains content that is associated with the phone number. Therefore, such communication between a caller and a recipient prior to the commencing of the phone call will not be possible when there is no internet connection at the time of the phone call.

Secondly, such approaches require constantly running an application that listens in the background to incoming phone calls. Using a listener application will be a burden on system resources of the recipient phone, may raise privacy and security concerns with users in such a manner that will discourage them from installing the listener application altogether.

Thirdly, such approaches require overlaying the native user interface of the phone's operating system with another premade user interface during the phone call. Thus, causing some degree of discomfort to the user that will be required to interact with an unfamiliar or an uncomfortable user interface. In addition, some vendors of phone operating systems prevent such overlaying of user interface therefore, preventing this type of preferable form of communication.

In light of the above, it is clear that a different approach is sought that will overcome the deficiencies in the field and that shall effectively provide a caller to convey information to a recipient prior to answering a phone call.

### SUMMARY OF THE INVENTION

The present invention discloses methods for communication prior to acceptance of a phone call. A method of the present invention comprises the following steps:
generating at least one phone number;
generating at least one message to be presented upon receipt of a phone call;
generating at least one Rich Contact containing said message and said phone number;
transmitting said at least one Rich Contact to a recipient phone device and further storing the Rich Contact therein;
initiating a phone call bearing a phone number of one of said Rich Contacts to said recipient phone device;
wherein, upon receipt of said phone call on said phone device, a default call application shall identify said phone number of said phone call and present said message from within said Rich Contact associated with said phone number.

It is within the provision of the invention that the message comprised of the following: name of the caller, caller's logo, an image containing visual and textual content, sounds and etc. . . .

It is within the provision of the invention that the message is comprised of a Rich Image having a certain resolution, such that certain areas of the image contain visual or textual elements. Each of the visual or textual elements is uniquely identified by a set of coordinates in the Rich Image.

In this aspect of the invention, the Rich Contact further comprises a script indicating an order, timing, and placing of any of said visual or textual elements for presentation upon receipt of a phone call.

In this aspect of the invention, upon receipt of said phone call on said phone device, a call application shall identify the phone number of the phone call and present said message from said Rich Contact associated with said phone number, as dictated by said script.

For example: For a duration of 5 seconds, element A in coordinates x1, y1 of the Rich Image shall be located on a portion of the screen delimited by coordinates a1, b1 of the screen, and then, fade out.

The present disclosure also includes methods for generating the messages to be presented upon receipt of a phone call.

As the astute reader shall understand, performing the method disclosed above, and any additional methods disclosed herein, would allow to overcome the above described deficiencies in the field.

Firstly, the present invention does not require a continuous internet connection to access a remote database Rich Contacts may be pushed, updated, and revised in any given time when there is an appropriate internet connection for future use. Therefore, the functionality of the present invention will not be harmed upon a momentary lack of internet connection.

Secondly, the present invention does not require constantly running an application that listens in the background to incoming phone calls. Thus, conserving system resources of the recipient phone, and alleviate privacy and security concerns with users.

Thirdly, the present invention does not require overlaying the native user interface of the phone's operating system with another premade user interface during the phone call. Thus, allowing the user to interact with his chosen familiar and comfortable user interface. In addition, this invention will function with operating systems that prevent such overlaying of user interface.

### BRIEF DESCRIPTION OF THE DRAWINGS

The invention can be more fully appreciated in connection with the following detailed description, taken in conjunction with the accompanying drawings, in which:

FIG. 1 illustrates an exemplary system for performing the methods of the present invention.

FIG. 2 is a flowchart of a method of the present invention.

FIG. 3 illustrates an exemplary system for performing the methods of the present invention.

FIG. 4 is a flowchart of a method of the present invention.

FIG. 5 is a flowchart of a method of the present invention.

FIG. 6 is a system for generating messages to be presented upon receipt of a phone call.

FIG. 7 is a flowchart of a method for generating messages to be presented upon receipt of a phone call.

FIG. 8 is an illustration of a screen displaying an exemplary message generated by the methods and systems of the present invention.

### DETAILED DESCRIPTION OF THE PREFERRED EMBODIMENTS

The present invention will be understood from the following detailed description of preferred embodiments, which are meant to be descriptive and not limiting. For the sake of brevity, some well-known features, methods, systems, procedures, components, and so on, are not described in detail.

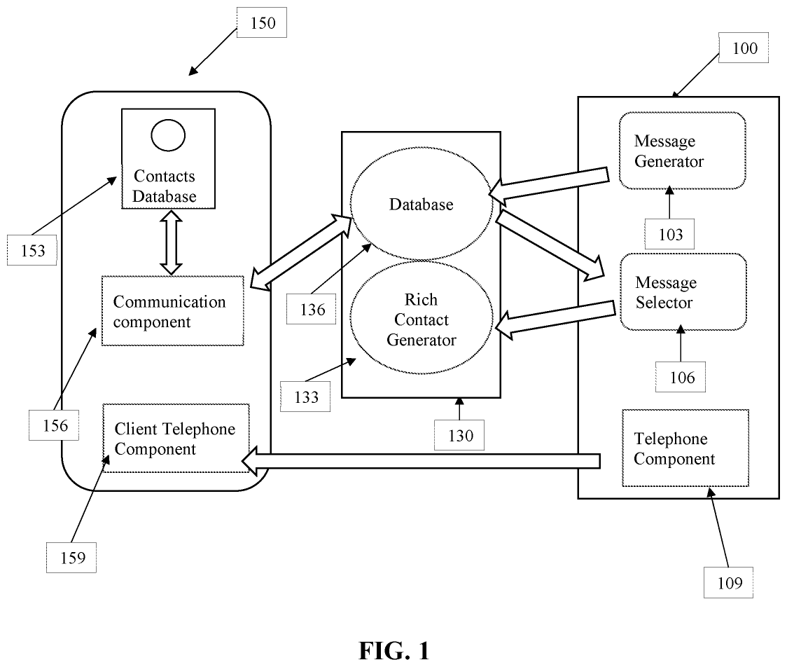

Referring initially to FIG. 1. The system depicted in this figure is configured to perform some methods disclosed herein.

The illustrated system includes an outgoing call generator 100, a distant server 130, and a recipient phone device 150. The outgoing call generator 100, and the distant server 130 may be part of a single computer or may be operated from separate locations and by different organizations. As such, the outgoing call generator 100, and the distant server 130 are computers configured by software or firmware to perform their roles within the present invention.

The outgoing call generator 100 includes a message generator 103 which is preferably a software module used to generate messages and store them in a database 136. The message selector 106 is preferably also a software module that is used to select a message from the database 136 and transmit it to the Rich Contact Generator 133.

The Rich Contact Generator 133 in the server 130, is preferably a software module used to generate Rich Contacts and transmit them to the recipient phone device 150. The communication component 156 is a component that is traditionally used to facilitate internet communication. The Contacts Database 153 is a database that stores all the contacts (name, contact information, picture, etc. . . . ) within the recipient phone device 150 including any Rich Contacts received from the Server 130.

The Telephone Component 109 is a phone device/component configured to place outgoing calls bearing a phone number that is indicated in any Rich Contact generated by the Rich Contact Generator 133 and saved in the Contacts Database 153.

The Client Telephone Component 159 is a phone component within the recipient phone device 150. The Client Telephone Component 159 receives a call and identifies the caller telephone number by comparing it to entries within the Contacts Database 153.

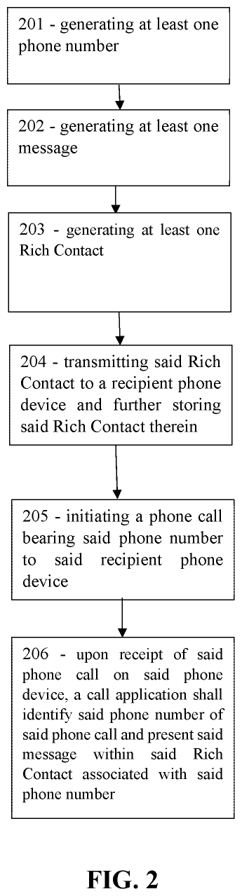

Referring to FIG. 2. Depicted is a method for communication prior to acceptance of a phone call comprising the following steps:
a. generating at least one phone number 201.
   This step may be performed by be defining a single fixed constant phone number, but also may be performed by generating ad-hoc plurality of phone numbers for various uses and occasions.
b. generating at least one message to be presented upon receipt of a phone call 202.
   A message in the meaning of this invention may be any type of content (e.g., visual, textual, vocal content) in any digital format that also conforms to any formats that are used to store contact data in digital devices (e.g. VCF, CSV).
   For example, a message may be composed of a textual string indicating the caller's name, an image indicating the caller's logo, and another image that may be a photo or a textual message indicating the purpose of the phone call.
   This step may be performed by a software module such as the Message Generator (FIG. 1, 103).
c. Generating at least one Rich Contact containing said message and said phone number 203.
   This step may be performed by a software module such as the Rich Contact Generator (FIG. 1, 133).
   The Rich Contact Generator will process any content selected by the Message selector (FIG. 1, 106) and combine it with the previously generated phone number, into a single contact file in any known and suitable format such as the VCF format (Virtual Contact File).
d. transmitting said at least one Rich Contact to a recipient phone device and further storing said at least one Rich Contact therein 204.
   This step may be performed by an application installed on the recipient phone device and configured to receive Rich Contacts via Push, Pull or any other known methodology. The application will then catalog the Rich Contact and store the Rich Contact in the regular Contacts Database of the recipient phone device.
   It is within the provision of the invention that the application will keep a log of the Rich Contacts stored in the recipient phone device, and allow the Server (FIG. 1, 130) to monitor various characteristics of the Rich Contacts (e.g., type of message, date of message, phone number, name of caller, etc) and provide updates as required.
e. initiating a phone call bearing a phone number of one of said Rich Contacts to said recipient phone device 205.
   Once a phone call bearing a phone number of one of the Rich Contacts saved in the recipient phone device, was initiated, the phone device will identify the incoming phone number and will present the message that is content encoded in the Rich Contact, to the user.

One apparent use of the invention will be understood from the following illustrative scenario. A bank wants to call one of its clients and inform him regarding a status of a loan request. The bank is concerned that the client will not recognize the phone number and will avoid answering the phone call. With the use of the present invention, the bank's representative will create a message that is comprised of the bank's name as the caller's name, an image of the bank's logo, and an image that consist of a textual message informing regarding the purpose of the phone call.

The inventive system will combine the message and the phone number into a Rich Contact and transmit it to the recipient phone device. Once the phone call is initiated, the native phone call application in the recipient phone device will present to the user the message embedded in the Rich contact associated with this phone number, and the user will gain vital information prior to answering the phone call.

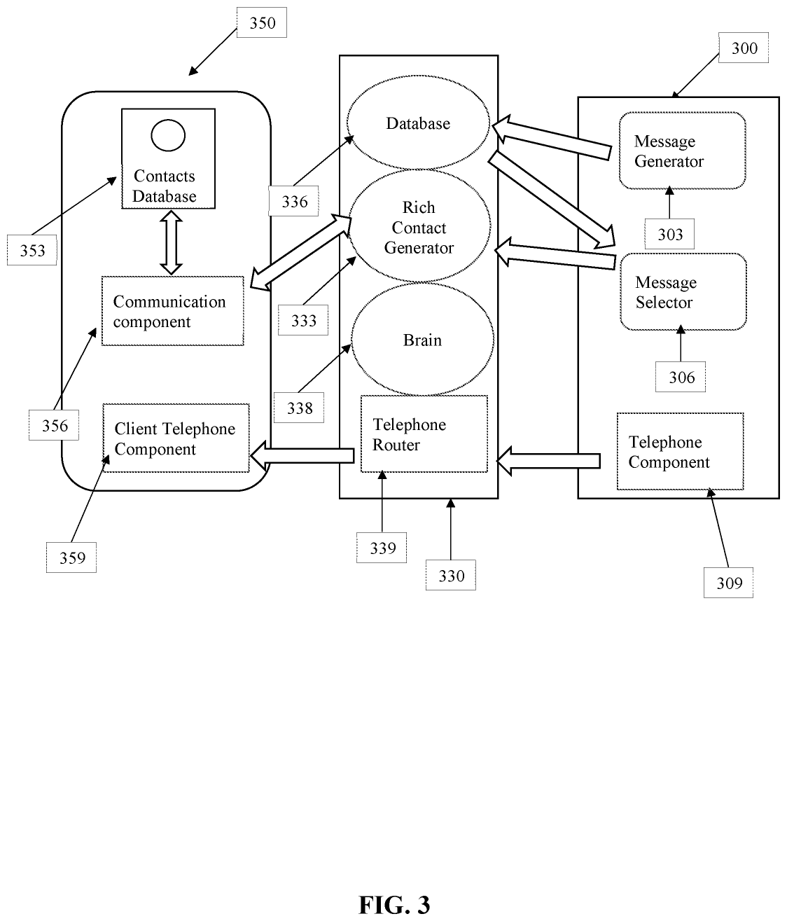

Referring to FIG. 3. The system depicted in this figure is configured to perform some methods disclosed herein.

The illustrated system includes an outgoing call generator 300, a distant server 330, and a recipient phone device 350. The outgoing call generator 300, and the distant server 330 may be part of a single computer or may be operated from separate locations and by different organizations. As such, the outgoing call generator 300, and the distant server 330 are computers configured by software or firmware to perform their roles within the present invention.

The outgoing call generator 300 includes a message generator 303 which is a software module used to generate messages and store them in a database 336. The message selector 306 is also a software module used to select a message from the database 336 and transmit it to the Rich Contact Generator 333.

The Rich Contact Generator 333 in the server 330, is a software module used to generate Rich Contacts and transmit them to the recipient phone device 350. The communication component 356 is a component that is traditionally used to facilitate internet communication. The Contacts Database 353 is a database that stores all the contacts (name, contact information, picture, etc. . . . ) within the recipient phone device 350 including any Rich Contacts received from the Server 330.

The Brain 338 is a program in communication with the Contacts Database 353 configured to find if a certain message selected by the Message Selector 306 exists in a certain Rich Contact in the Contacts Database 353 of a recipient phone device. If a match is found, the Brain 338 will switch the Telephone Router 339 or instruct it to switch the phone number of the phone call dialed by the Telephone Component 309 to the phone number that is indicated in the Rich Contact.

The router may be a physical device, a software module, an external service or any kind of system that enables the functionality described herein.

The Telephone Component 309 is a phone device/component configured to place outgoing calls bearing a phone number that is indicated in any Rich Contact generated by the Rich Contact Generator 333 and saved in the Contacts Database 353.

The Client Telephone Component 359 is a phone component within the recipient phone device 350. The Client Telephone Component 359 receives a call and identifies the caller telephone number by comparing it to entries within the Contacts Database 353.

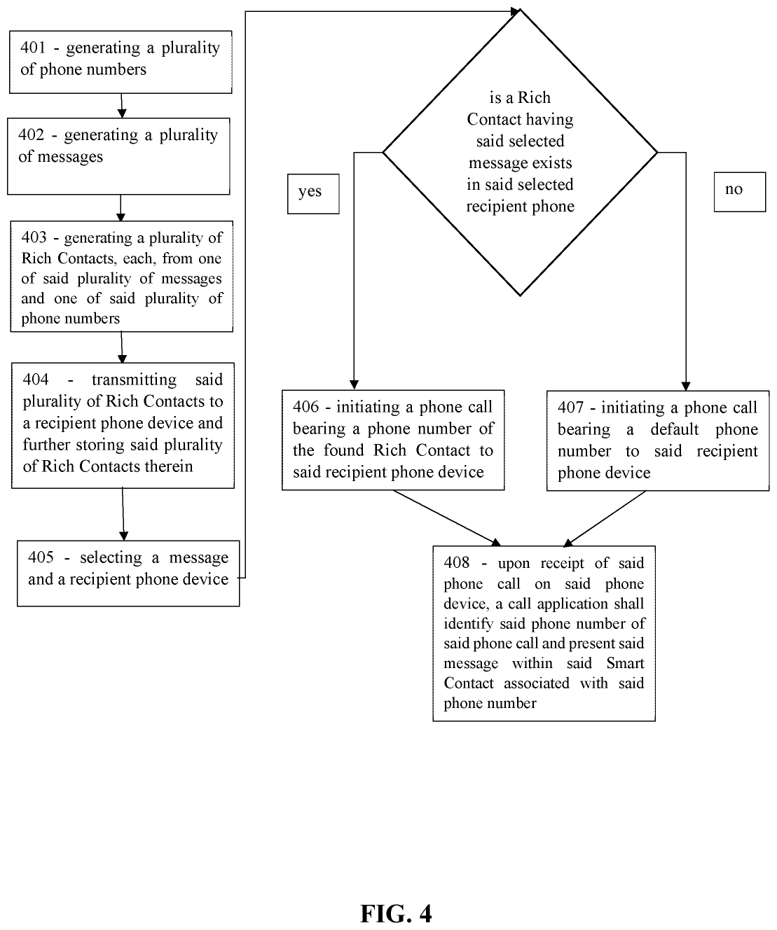

Referring to FIG. 4. Depicted is a method for communication prior to acceptance of a phone call comprising the following steps:
a. generating a plurality of phone numbers 401.
b. generating a plurality of messages 402.
c. generating a plurality of Rich Contacts, each, from one of said plurality of messages and one of said plurality of phone numbers 403.
d. transmitting said plurality of Rich Contacts to a recipient phone device and further storing 210 said plurality of Rich Contacts therein 404.
e. selecting a message and a recipient phone device 405.
f. if a Rich Contact having said selected message exists in said selected recipient phone device, initiating a phone call bearing a phone number of the found Rich Contact to said recipient phone device 406.
g. else, initiating a phone call bearing a default phone number to said recipient phone device 407.

wherein, upon receipt of said phone call on said recipient phone device, a call application shall identify said phone number of said phone call and present said message within said Rich Contact associated with said phone number 408.

One apparent use of the invention will be understood from the following illustrative scenario. A bank has found that he has several call purposes: a marketing call; a call for informing the status of a client's bank account; a call for presenting an answer to a client's query, etc. . . .

The bank is concerned that a single generic message to be presented with receipt of the phone call will not be informative for the client.

With the use of the present invention, the bank will create a plurality of messages for each purpose. Each message is comprised of the bank's name as the caller's name, an image of the bank's logo, and an image that consist of a textual message informing regarding the specific purpose of each phone call.

The inventive system will combine each message with a phone number into a Rich Contact and transmit. Since there are several messages, there will be several Rich Contacts, each with an attached unique phone number. The plurality of Rich Contacts will be transmitted to the recipient phone device.

A native application installed on the recipient phone device will monitor the Rich Contacts in the device and update them when required. When the bank will want to initiate a phone call to a client, it will choose the purpose of the call and select an appropriate message (e.g. “this is a call regarding your bank account status”). The system will then check if a Rich Contact exists in the recipient phone device. If yes, the system will initiate a phone call bearing the phone number that is in the Rich Contact. If not, the system will initiate a phone call under a phone number that is indicated in a Rich Contact within the recipient phone device, for use in a default incoming phone call from the bank. In this specific scenario, the message of the default Rich Contact is composed of the bank's name and logo.

Once the phone call is initiated, the native phone call application in the recipient phone device will present to the user the message embedded in the Rich contact associated with this phone number, and the user will gain vital information prior to answering the phone call.

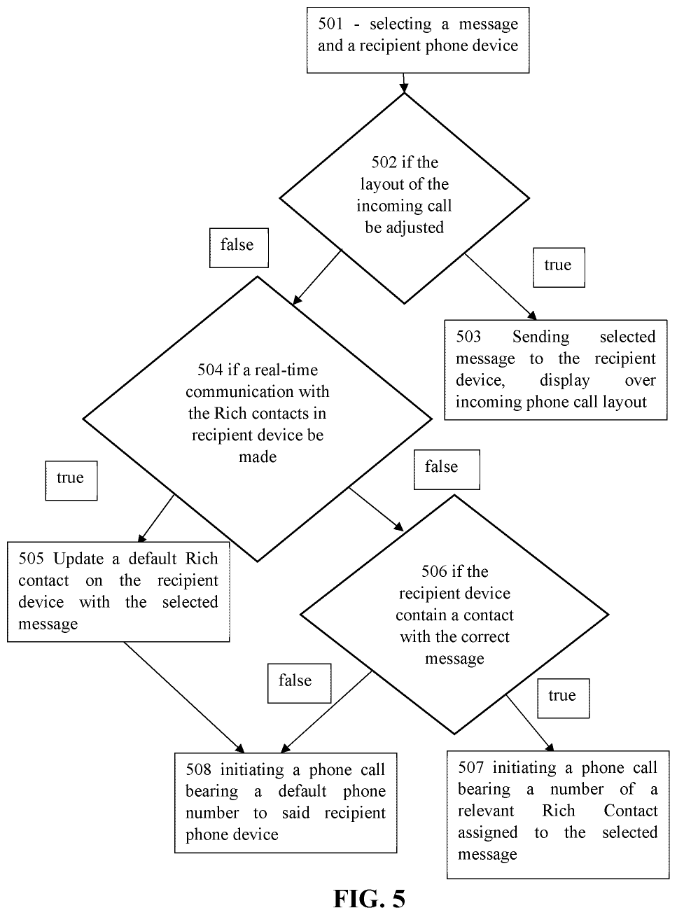

Referring to FIG. 5. Depicted is a method for ensuring correctness of a message presented to a recipient. This method will be applicable where a plurality of phone numbers for placing outgoing calls may be used and where a plurality of messages may be generated, in advance or ad-hoc. The method is comprised of the following steps:
a. selecting a message and a recipient phone device 501.
b. Checking if the layout of the user interface intended for presenting the selected message on the recipient phone device can be adjusted in real time 502.
c. If true, sending selected message to the recipient device, and further displaying said selected message over incoming phone call layout of the recipient phone device 503.
d. Else, checking if a real-time communication and editing the Rich contacts in recipient device be made 504.
e. If true, updating a default Rich contact on the recipient device with the selected message 505, and further, initiating a phone call bearing a default phone number to said recipient phone device 507.
f. Else, checking if the recipient device contains a Rich Contact with the selected message 506.
g. If true, initiating a phone call bearing a number of a relevant Rich Contact assigned to the selected message 507.
h. Else, initiating a phone call bearing a default phone number to said recipient phone device 508.

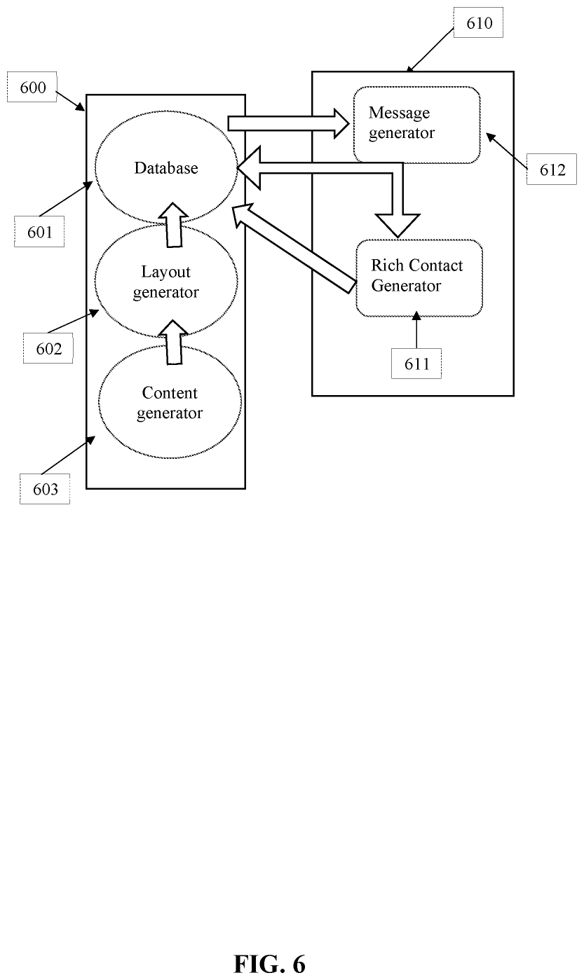

Referring to FIG. 6. The optional system depicted in this figure is configured to perform methods for generating messages to be displayed upon receipt of a phone call.

The depicted system is comprised of 2 distinct computers 600, 610 interfacing with each other. It should be mentioned that this is only exemplary network topology and any other suitable topology may be used. For example, a single computer may be used as a server for running all required software modules, connected to terminals that allow for user interface with the server.

The layout generator 602, content generator 603, rich contact generator 611, and message selector 612 are software modules each having a functionality as described below. all software modules may be part of a single computer program or alternatively, constitute a standalone program in computer interface with the other software modules.

It is also considered that at least some functionality of the software modules may be manually performed by a user having access to various visual editing software.

The content generator 603 allows creating a visual message components to be displayed upon receipt of a phone call. For example, generating a message that includes a and stylized texts having certain characteristics such as a font having a color and size, and an image chosen from an image repository or created ad-hoc.

The layout generator 602 allows creating layout templates of messages having such attributes as usable screen dimensions in a caller app, background color, coordinates in layout for text(s), coordinates in layout for image(s), and frames for framing text and image.

The database 601 is used to store content, layout templates, messages, and rich contacts created by the content generator 603, layout generator 602, message generator 612, and rich contact generator 611, respectively.

The message generator 612 retrieves content and layout templates stored in the database 601 and combines them in a single message to be presented upon receipt of a phone call. This is achieved by inserting the content in predefined areas in templates.

For example, a layout template containing an area in the center of the screen, defined as an image area. The same template also contains another area defined as text area. The message generator 612 shall insert visual content in the image area and textual content in the text area. The message generator 612 shall further export the resulting message into a single image and forward it to the rich contact generator 611 for further use, or alternatively, store the message in the database 601 for future use.

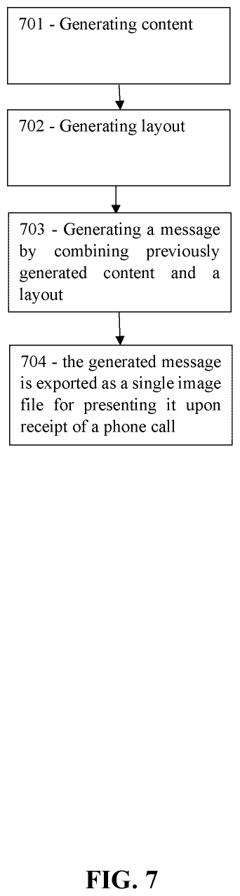

Referring to FIG. 7. Depicted is an optional method for generating messages to be presented upon receipt of a phone call. The method is comprised of the following steps:
a. Generating content comprising any of the following: visual stylizing (e.g., fonts, text color and style, color tints of other visual elements, visual content (e.g., pictures), and textual content 701.
b. Generating a layout template comprising any of the following: background color, image area, and text area 702.
c. Generating a message by combining previously generated content and layout template 703. This step may be performed by inserting the generated content into the layout template as is or by modifying the content in any way necessary to make it compatible with the layout.

The generated message is further exported as a single image file for presenting it upon receipt of a phone call.

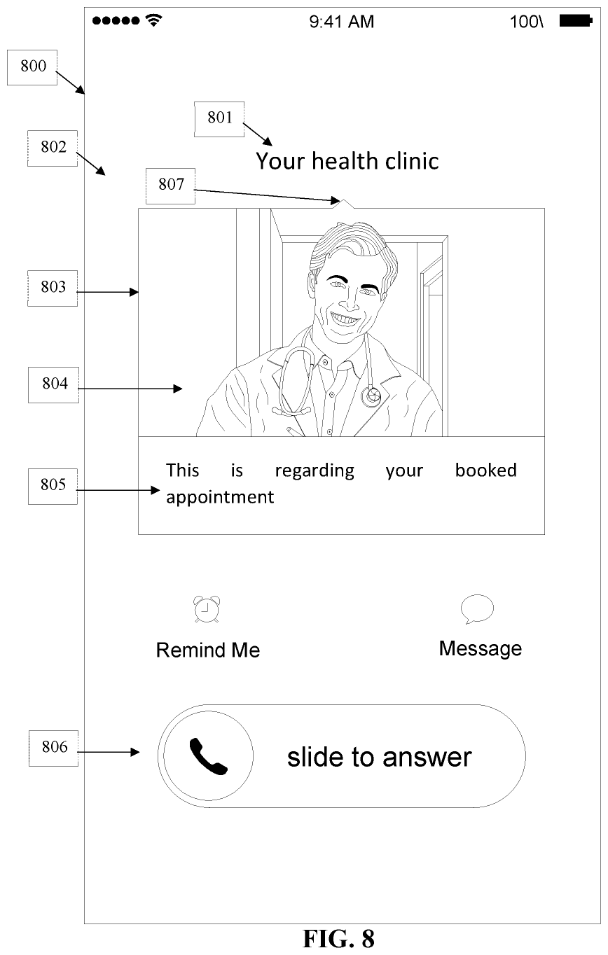

Referring to FIG. 8. Depicted is a screenshot of a smartphone receiving a phone-call via the Rich contact methodology of the present invention.

The display of the smartphone 800 presents to the user the regular UI intended for answering or rejecting a phone call 806.

If the present invention was not used, then the only other element presented on the screen would be the caller's phone number, since it is given that the caller is not known to the recipient.

In this case, the caller uses methods of the present invention and therefore, the screen contains additional elements that introduce the caller to the recipient and motivate him to answer the phone call.

The screen contains the caller identifier 801, in this case, the text “Your health clinic”. As explained in previous portions of this disclosure, the caller identifier is indicated in the Rich contact file sent to the recipient phone device at any point of time prior to the initiation of a phone call.

The screen display also contains the following elements:
a. visual content 804 that is a picture of a doctor.
b. Textual content 805 that is the wording “This is regarding your booked appointment”.
c. A frame 803 that divides the textual content and visual content from the rest of the screen. The frame in this case is rectangular with a pointer 807 referring to the caller identifier 801. It should be mentioned that any other shape and stylizing of the frame may be implemented.
d. A background 802 that may be transparent, or of any color or image.

The foregoing description and illustrations of the embodiments of the invention has been presented for the purposes of illustration. It is not intended to be exhaustive or to limit the invention to the above description in any form.

1. A method for communication prior to acceptance of a phone call comprising the steps of:
generating at least one phone-number and at least one message to be presented on a recipient phone-device upon receipt of a phone-call from a phone-number generated;
generating at least one Rich-Contact, each of which, containing a message and a phone-number of said at least one message and said at least one phone-number;
transmitting said at least one Rich Contact to a recipient phone-device, and thereafter, storing said at least one Rich Contact within a database of a recipient phone-device;
initiating a phone-call using a phone-number associated with one of said at least one Rich Contacts to a recipient phone-device that stores said associated Rich-Contact;
wherein, upon receipt of said phone-call on a recipient phone-device, a call application shall identify said phone-number of said phone-call and present said message from within said Rich Contact.

2. The method of claim 1, further comprising the step of:
if a certain message exists in a Rich Contact in a database of a recipient phone-device, switching a phone-number of an initiated phone call to a phone-number that is indicated in said Rich-Contact of said certain message.

3. The method of claim 1, further comprising the step of:
creating visual message components to be displayed upon receipt of a phone call, said message components are selected from a group comprising of images and stylized texts;
creating layout templates for messages, having attributes from a group comprising of: usable screen dimensions in a caller app, background color, coordinates in layout for text, coordinates in layout for image, and frames for framing text and image;
combining said visual message components and said layout templates into a message to be presented upon receipt of a phone call, by inserting said visual message components in predefined areas in said layout templates.

4. The method of claim 1, further comprising the step of:
selecting a message and a recipient phone device;
if layout of user interface intended for presenting said selected message on said recipient phone device can be adjusted in real time, sending selected message to said recipient device, and further displaying said selected message over incoming phone call layout of said recipient phone device;
else if a real-time communication and editing the Rich contacts in recipient device can be made, updating a default Rich contact on said recipient device with said selected message, and further, initiating a phone call bearing a default phone number to said recipient phone device;
else if said selected recipient device contains a Rich Contact with said selected message, initiating a phone call bearing a number of a relevant Rich Contact assigned to said selected message;
else, initiating a phone call bearing a default phone number to said recipient phone device.

5. A system for communication prior to acceptance of a phone call comprising:
an outgoing call generator and a server in electronic communication with at least one recipient phone-device;
wherein, said server includes a Rich-Contact Generator;
further wherein, said outgoing call generator includes a message generator for generating messages and storing them in a database and a message selector for selecting a message from a database and transmitting it to said Rich-Contact Generator;
further wherein, said Rich-Contact Generator is configured to generate Rich Contacts and transmit them to at least one recipient phone-device;
further wherein, said outgoing call generator includes a Telephone Component that is configured to place outgoing calls bearing a phone-number that is indicated in any Rich-Contact generated by said Rich-Contact Generator and stored in a contacts database of a recipient phone-device.

6. The system of claim 5, wherein said server further comprising:
a telephone router;
a Brain module configured to find if a message selected by said Message Selector exists in a certain Rich Contact in a database of a recipient phone-device and to select that Rich-Contact;
said Brain module is further configured to switch said Telephone Router, such that a phone call placed by said Telephone Component will bear a phone number that is indicated in a Rich-Contact selected by said Brain module.

7. The system of claim 5, wherein said server further comprising:
a layout generator and a content generator;
wherein, said content generator is configured to create visual message components to be displayed upon receipt of a phone call, said message components are selected from a group comprising of images and stylized texts;
further wherein, said layout generator is configured to create layout templates for messages, having attributes from a group comprising of: usable screen dimensions in a caller app, background color, coordinates in layout for text, coordinates in layout for image, and frames for framing text and image;
further wherein, said message generator is configured to retrieve visual message components and layout templates from a database and combine them into a message to be presented upon receipt of a phone call, by inserting said visual message components in predefined areas in said layout templates.
